(19) United States
(12) Patent Application Publication
(10) Pub. No.: US 2008/0005462 A1
(43) Pub. Date: Jan. 3, 2008

(54) METHOD OF CONFIGURING NON-VOLATILE MEMORY FOR A HYBRID DISK DRIVE

(75) Inventors: Hong Beom PYEON, Kanata (CA); HakJune OH, Kanata (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, US

(73) Assignee: MOSAID TECHNOLOGIES INCORPORATED, Kanata (CA)

(21) Appl. No.: 11/428,050

(22) Filed: Jun. 30, 2006

(51) Int. Cl. G06F 13/00

(52) U.S. Cl. 711/113

(57) ABSTRACT

A method is provided to operate a non-volatile memory (NVM) in a hybrid drive mode in response to a user selection. To operate in hybrid drive mode, a computer operating system and a basic input/output system are preferably updated to identify the NVM as part of the same logical bootable disk, or logical hybrid drive, as a hard disk drive. Bootable disk sector and address mapping can be modified to reflect the addition or removal of the NVM. The NVM is preferably user-replaceable and upgradeable without opening the computer's casing. When the NVM includes more than one NVM module, a first NVM module can operate in hybrid disk mode while a second NVM module operates in a normal storage mode. Since no internal hardware modification is required, this approach can provide hybrid disk performance using conventional hardware, or to enhance performance of an existing hybrid drive.

### FIELD OF THE INVENTION

The present invention relates generally to a hybrid disk configuration. More particularly, the present invention relates to non-volatile memory and its use with a hard disk drive as part of a hybrid disk.

### BACKGROUND OF THE INVENTION

Generally, the processing speed of a computer's central processing unit (CPU) has increased far more quickly than the access speed for a computer's hard disk drive (HDD). This speed gap between the CPU and the HDD contributes to application delay and can also increase power usage due to excessive spinning of the HDD. A hybrid drive is a computer hard drive configuration that addresses this speed gap. In a hybrid drive, non-volatile memory is used to supplement the spinning hard disk drive, in order to provide faster boot and resume by using faster memory, and to provide lower power consumption by keeping the HDD's spindle motor in idle mode more often. Such a hybrid drive configuration is particularly advantageous for battery operated computer systems, such as mobile computers or other mobile computing devices.

A simplified known hybrid drive configuration will be described. Referring to FIG. 1A which shows a known hybrid drive configuration 100, a non-volatile memory (NVM) cache 102 is added to be physically part of an HDD 104, to store frequently used sectors for fast boot and resume times. The HDD 104 with its on-board NVM cache 102 is placed on a system board, or motherboard, 106. Such an approach is typically supported by the computer's operating system.

Referring to FIG. 1B which shows another known hybrid drive configuration 110, an NVM cache 112 is provided directly on a computer's system board 114 and is in communication with an HDD 116 via the system board 114. If the entire operating system (O/S) is loaded in the NVM 112, booting can occur directly from the cache.

In each of the configurations in FIGS. 1A and 1B, a 128 MB minimum is currently recommended for the non-volatile memory cache. Non-volatile memory can be implemented in a hybrid HDD by way of an embedded flash disk, a one-chip solution using NAND flash memory die with existing HDD controllers, or a NAND flash memory die with a dedicated NAND controller.

U.S. Pat. No. 5,778,418 granted to Auclair et al. on Jul. 7, 1998 teaches the use of a common memory controller circuit to mediate access of the operating system to a combined mass storage system including a flash electrically erasable programmable read-only memory system and a rotating disk drive memory.

However these approaches cannot be used with existing computer hardware setups. The configuration in FIG. 1A requires a hard disk upgrade, where the new modified hard disk with NVM can have a unique form factor and require a unique interface. The configuration in FIG. 1B requires a system board upgrade, though a conventional HDD can be used. The approach in taught in U.S. Pat. No. 5,778,418 requires extra hardware in the form of a common memory controller circuit. In all of these approaches, the NVM memory is only dedicated for use as a non-volatile hard disk cache and is not easily replaced or upgraded.

Some operating systems permit creation of a “boot disk”. This is typically done on a removable medium for a spinning drive (floppy disk, CD or DVD), which can only hold a subset of the O/S booting portions for emergency purposes, and cannot hold the entire O/S. There is typically no space left on the removable medium for a spinning drive to act as a non-volatile cache for the hard disk drive. Moreover, since it is intended for use in a spinning drive, this boot disk approach does not solve the problem of decreased access speed and increased power consumption caused by spinning motors.

### SUMMARY OF THE INVENTION

In a broad aspect, the present invention provides a method of configuring an NVM in a computer system having a hard disk drive, an O/S and a BIOS. The method includes the following steps: receiving a user selection of a hybrid drive mode for the NVM; copying boot portions of the O/S to the NVM in response to the user selection; and assigning the hard disk drive (HDD) and the NVM as a logical hybrid drive of the computer system.

For example, the NVM is a non-volatile HDD cache. Advantageously, prior to the step of receiving the user selection, the method can further include configuring the NVM to operate in a normal storage mode. The step of assigning can include: assigning the HDD and the NVM to a logical hybrid bootable disk; modifying bootable disk sector and address mapping to include the NVM; or modifying the BIOS to identify the NVM as the non-volatile HDD cache.

In a case where the NVM includes first and second NVM modules, the method can further include: copying the boot portions of the O/S to the first NVM module and defining the logical hybrid drive to include the first NVM module, to operate the first NVM module in the hybrid drive mode; and operating the second NVM module in a normal storage mode while the first NVM module operates in the hybrid drive mode.

Advantageously, the hybrid drive mode can be disabled in response to a hybrid drive mode termination condition for the NVM, such as disconnection or removal of the NVM. After the step of disabling, the NVM can be removed from the defined logical hybrid drive, and the bootable disk sector and address mapping can be modified to remove the NVM.

In another aspect, the present invention provides a computer system including an HDD, an NVM, an O/S and a BIOS. The computer system includes a machine-readable medium storing commands and instructions which, when executed, cause a processor to perform a method of configuring a non-volatile memory. The method includes: receiving a user selection of a hybrid drive mode for the NVM; copying boot portions of the O/S to the NVM in response to the user selection; and assigning the hard disk drive and the NVM to a logical hybrid drive of the computer system, the NVM being a non-volatile HDD cache.

Advantageously, the NVM can be removable and replaceable without performing an internal computer system hardware upgrade. The computer system can further include a receiver for receiving the NVM, the receiver being in electrical communication with the processor. The receiver can be a slot for receiving the NVM, which is accessible by a user without opening the outer casing. The slot can include a securing mechanism to prevent disconnection of the NVM when the NVM is being used in hybrid drive mode. The NVM can be a flash memory card.

In the case where the NVM includes first and second NVM modules, the first NVM module can include the boot portions of the O/S and the logical hybrid drive is defined to include the first NVM module; the first NVM module being operable in the hybrid drive mode. The second NVM module is operable in a normal storage mode while the first NVM module is operable in the hybrid drive mode. The first and second NVM modules can be logical NVM modules or physical NVM modules.

In a further aspect, the present invention provides a machine-readable medium storing commands and instructions which, when executed, cause a processor to perform a method of configuring an NVM in a computer system having an HDD, an O/S and a BIOS. The method includes: receiving a user selection of a hybrid drive mode for the NVM; copying boot portions of the O/S to the NVM in response to the user selection; and assigning the hard disk drive and the NVM to a logical hybrid drive of the computer system, the NVM being a non-volatile HDD cache. The commands and instructions stored on the machine-readable medium can perform other steps in the method, as described earlier.

In a yet further aspect, the present invention provides a non-volatile memory device operable in a hybrid disk mode or a normal storage mode in response to a user mode selection.

In accordance with embodiments of the present invention, there is provided a hybrid drive configuration with greater flexibility and backward-compatibility with existing hardware.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1A and FIG. 1B illustrate known hybrid hard drive configurations;

FIG. 2A illustrates a hybrid hard drive configuration according to an embodiment of the present invention;

FIG. 2B illustrates a hybrid hard drive configuration according to another embodiment of the present invention;

FIG. 3 illustrates a method of enabling a hybrid cache mode in a non-volatile memory according to an embodiment of the present invention;

FIG. 4 illustrates a method of disabling or terminating a hybrid cache mode in a NVM according to an embodiment of the present invention;

FIG. 5 illustrates a method of enabling a hybrid cache mode in a first NVM module while enabling a data storage in second NVM module according to an embodiment of the present invention;

FIG. 6 illustrates a method of enabling a hybrid cache mode in a non-volatile memory upon operating system installation according to an embodiment of the present invention;

FIGS. 7A, 7B, 7C, 7D, 7E and 7F illustrate allocation of bootable operating system codes, or boot portions of the O/S, in a non-volatile memory and in a hard disk drive according to embodiments of the present invention;

FIGS. 8, 9 and 10 illustrate disk assignment after enabling a hybrid cache mode in a non-volatile memory according to embodiments of the present invention; and

FIG. 11 illustrates a machine-readable medium storing commands and instructions according to an embodiment of the present invention.

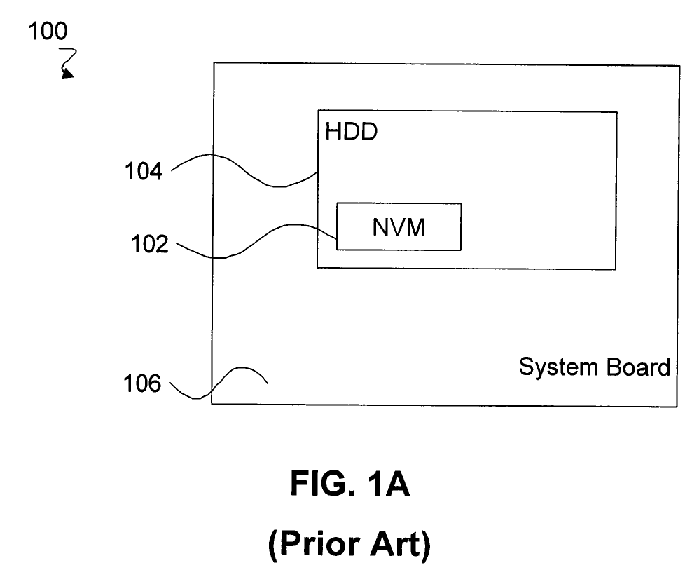

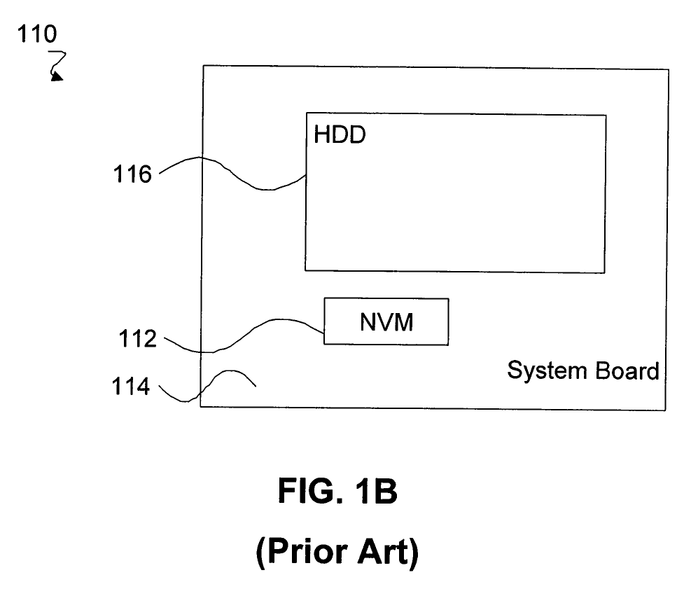

### DETAILED DESCRIPTION

Generally, the present invention provides a method of operating an NVM in either a hybrid drive mode or a normal storage mode, in response to a user selection. To operate in hybrid drive mode, a computer O/S and BIOS are preferably updated to identify the NVM as part of the same logical bootable disk, or logical hybrid drive, as an HDD. Bootable disk sector and address mapping can be modified to reflect the addition or removal of the NVM. The NVM is preferably user-replaceable and upgradeable without opening the computer's casing. When the NVM includes more than one NVM module, a first NVM module can operate in hybrid disk mode while a second NVM module operates in normal storage mode. Since no internal hardware modification is required, this approach can provide hybrid disk performance using conventional hardware, or to enhance performance of an existing hybrid drive.

In the following detailed description of sample embodiments of the invention, reference is made to the accompanying drawings which form a part hereof, and in which are shown by way of illustration specific sample embodiments in which the present invention can be practiced. These embodiments are described in sufficient detail to enable those of ordinary skill in the art to practice the present invention, and it is to be understood that other embodiments can be utilized and that logical, electrical, and other changes may be made without departing from the scope of the present invention. In other instances, well-known electrical structures and circuits are shown in block diagram form in order not to obscure the present invention. The following detailed description is, therefore, not to be taken in a limiting sense, and the scope of the present invention is defined by the appended claims.

Embodiments of the invention can be represented as a software product stored in a machine-readable medium (also referred to as a computer-readable medium, a processor-readable medium, or a computer usable medium having a computer readable program code embodied therein). The machine-readable medium can be any suitable tangible medium, including magnetic, optical, or electrical storage medium including a diskette, compact disk read only memory (CD-ROM), memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine readable medium may interface with circuitry to perform the described tasks.

The term “non-volatile memory” as used herein represents a storage device whose contents are preserved when its power is off. In preferred embodiments, the non-volatile memory has very few, if any, moving parts, such as a solid-state electronic flash memory data storage device. Types of non-volatile memory include: mask-programmed ROM; programmable ROM (PROM); erasable PROM (EPROM), such as UV-erase EPROM and OTP (one-time programmable) ROM; electrically erasable PROM (EEPROM); flash memory; and battery-backed static RAM. Any multimedia card can be used, such as Smart Media, MultiMedia Card (MMC), Secure Digital (SD), extreme digital (xD), CompactFlash, Memory Stick, PCMCIA (Personal Computer Memory Card International Association), etc. Core memory typically consists of non-volatile cells, such as NAND-flash, NOR-flash, or other types of NV cells which are publicly released.

The term “BIOS” refers to software code run by a computer when it is first powered on. The BIOS prepares the computer so that other software programs stored on various media (such as hard drives, floppy drives, CDs, DVDs and other removable drives or removable media) can load, execute, and assume control of the computer. This process is known as booting up. BIOS can also be described as a coded program embedded on a chip that recognizes and controls various devices that make up the computer.

In the following description of embodiments of the present invention, the term “PC” is interchangeable with a computer system.

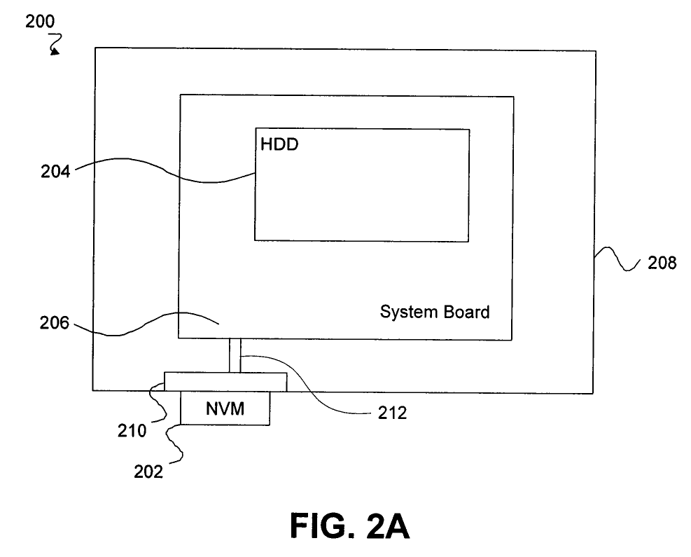

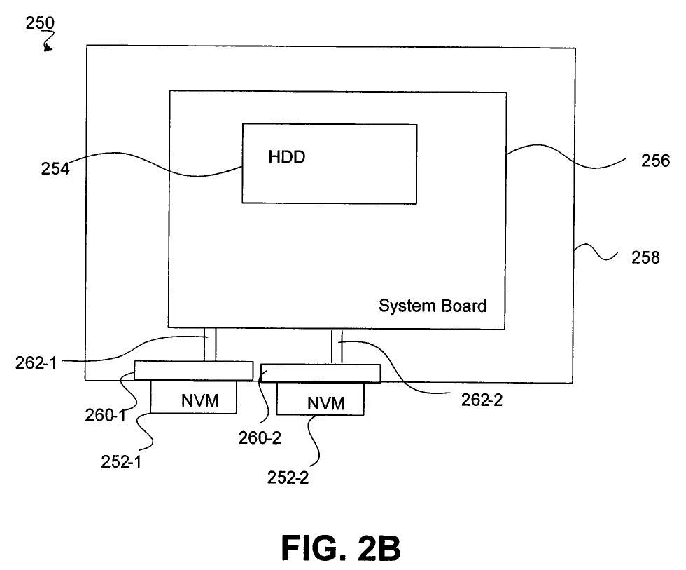

FIG. 2A shows a hybrid hard drive configuration according to an embodiment of the present invention. Referring to FIG. 2A, a hybrid drive configuration 200 includes an NVM 202 as a non-volatile hybrid disk cache for an HDD 204. The configuration of FIG. 2 does not need to update or modify hardware internal to the computer system, such as inside a system's casing 208. According to embodiments of the present invention, O/S and BIOS updates are used to manage a non-volatile cache that is preferably installed via one or more receivers 210 for interfacing the NVM 202 with a system board 206. The receivers can advantageously be implemented as NVM slots 210, which are a popular element of personal computer (PC) systems. The NVM slots 210 can be provided as external slots installed on the front side of the PC casing 208, or as a portable memory card reader connected to a universal serial bus (USB) port of the computer. In either case, the NVM slots 210 are in electrical communication with the system board 206 via a standard interface connection 212.

The configuration of FIG. 2A is a cost effective solution that can be applied to existing computer systems without internal hardware modification, providing ability to add non-volatile cache to a system where it is not built in. The slots provided externally (rather than internally on the system board) also provide the user with the ability to upgrade or change the size of the memory, and also to easily change the mode (i.e. cache memory mode or regular storage memory mode), since the user does not need to open the computer's exterior casing. This is particularly beneficial with a mobile computer (also known as a portable, notebook or laptop computer), since it is generally not possible to open up a mobile computer's case without voiding its warranty.

Moreover, in the case where the system includes a card reader as a means to provide the NVM slots 210, this avoids the problems of having diverse form factors and pin compatibility of different memory card formats by providing several card slots to install the memory cards without hassles. Using such an interface, various memory cards can be used to provide non-volatile (NV) caching. The throughput speed of bus interface of memory cards is not limited by the bus performance. Generally, the bus performance is higher than the flash memory read and write (program) performance. Any suitable type of bus configuration can be used with embodiments of the present invention. In fact, any interface is acceptable if the transmission speed exceeds the hybrid disk element system requirement. One example is a Peripheral Component Interconnect (PCI)-type bus with a north bridge and south bridge configuration where memory card slots, such as provided by a reader, are connected to the south bridge via a USB connection. Since there are many bus standards and interfaces to receive external data from outside source to PC system, it is to be understood that FIG. 2 shows an exemplary configuration to illustrate how to communicate data between the hard disk and NV cards. The connection used for the memory card slots or reader is not limited by this diagram, but includes any connection that enables the use of an external NVM card in the role of NV caching for hard disk, preferably without requiring direct connection of the NVM to either the hard disk drive or the system board.

The computer system assigns the NVM and the HDD to a logical hybrid drive, such as a logical bootable disk, or defines the logical hybrid drive as including the NVM and the HDD. In order to make PC system recognize a memory card as a NV cache, a method according to an embodiment of the present invention preferably updates the O/S and the BIOS. In general, the BIOS should support bootable disk mode for removable disk (label name of flash memory card in PC system) and the O/S has the ability to allocate new address mapping with two disk elements (rotating hard disk and flash memory card). There are two primary ways to implement such a method: on a computer system with a pre-installed O/S; and on a computer system during installation of the O/S.

FIG. 2B shows a hybrid hard drive configuration according to another embodiment of the present invention. Referring to FIG. 2B, a hybrid drive configuration 250 includes first and second NVM modules 252-1 and 252-2 as a non-volatile hybrid disk cache for an HDD 254. O/S and BIOS updates are used to manage the NVM modules 252-1 and 252-2 that are installed via first and second NVM slots 252-1 and 252-2. The NVM slots can be provided as external slots installed on the front side of the PC casing 258, or as a portable memory card reader connected to a USB port of the computer. In either case, the NVM slots 260-1 and 260-2 are in electrical communication with a system board 256 via first and second standard interface connections 262-1 and 262-2, respectively.

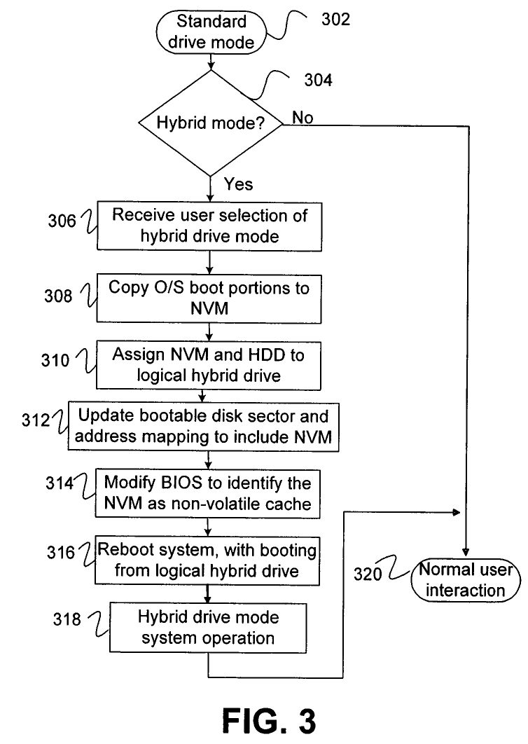

FIG. 3 illustrates a method of enabling a hybrid cache mode in a non-volatile memory according to an embodiment of the present invention. Most PC users have pre-installed O/S PC systems when a manufacturer ships them to customers. So, one embodiment provides the ability to assign the bootable disk to be a single logical hybrid disk, even though the logical bootable disk includes two physically separate memory devices, namely the NVM and the HDD. FIG. 3 shows a method for implementation of a hybrid disk system by allocation of O/S file-transferring to the flash memory card.

Referring to FIGS. 2A and 3, step 302 represents the PC in standard drive mode. Standard drive mode is a mode in which the HDD 204 is not operating in hybrid mode, and the NVM 202 (if present) is operating in normal storage mode. The normal storage mode is characterized by storage of user data, and in many cases user-controlled data storage, such as storage of documents, media files, etc. Prior to entering standard drive mode, the following steps may have occurred, particularly upon system startup: checking bootable disks, system booting, reading the O/S from a rotating disk, and loading all required files from the rotating disk. Booting in step 302 is done from the rotating hard disk storing all O/S files because the PC system does not know what type of flash memory card is inserted into the one of slots and it is not yet prepared to use flash memory card as a non-volatile (NV) cache. Sometime prior to step 304, the NVM 202 is inserted in the system (e.g., the NVM slot 210), such as in a memory card slot, and is recognized as a removable disk. In the subsequent steps, the PC system is configured to use a hybrid disk system including rotating hard disk and flash memory card that a user preferably puts into a slot.

In step 304, the user selects the desired operational mode for the NVM 202. As mentioned previously, the O/S preferably supports a hybrid drive mode; alternatively the method can include an optional step (not shown) of updating the O/S to be able to support hybrid drive mode. Following step 306 in which the user selection or enabling of hybrid drive mode is received, in step 308 the PC system starts transferring the bootable O/S files, or O/S boot portions or O/S booting section, to the NVM, such as a flash memory card. In step 310, the NVM 202 and HDD 204 are assigned to the logical hybrid drive, or logical bootable disk. Steps 312 and 314 can be considered as falling within the scope of defining the logical hybrid drive, or logical bootable drive, to include the NVM 202 and the HDD 204.

In step 312, address mapping regarding disk sector and disk size are modified. The sector size and disk address allocation are preferably determined based on the size of flash memory card. In step 314, the BIOS is updated to identify the NVM 202 as the non-volatile HDD cache. Once these steps are complete, in step 316 the PC system can reboot from the logical hybrid drive, including the flash memory card as non-volatile HDD cache, and the computer system can operate in hybrid drive mode in step 318. Upon completion of the hybrid drive mode system operation in step 318 or non-hybrid mode (i.e., the negative determination in step 304), the PC enters a state of normal user interaction in step 320. Normal user interaction refers to the fact that there is no NVM configuration being performed, and the user interacts with the PC as per normal operation. In the case where the method flows from step 318 to step 320, this signifies termination of the NVM configuration, whereas NVM configuration never really began when proceeding from the negative determination in step 304.

In other words, in a broad aspect, the present invention provides a method of configuring an NVM in a computer system having a hard disk drive, an O/S and a BIOS. The method includes the following steps: receiving a user selection of a hybrid drive mode for the NVM; copying boot portions of the O/S to the NVM in response to the user selection; and assigning the hard disk drive (HDD) and the NVM to a logical hybrid drive of the computer system, or as a logical hybrid drive of the computer system. The NVM can be a non-volatile HDD cache. Advantageously, prior to the step of receiving the user selection, the method can further include configuring the NVM to operate in a normal storage mode. The step of assigning can include: assigning the HDD and the NVM to a logical hybrid bootable disk; modifying bootable disk sector and address mapping to include the NVM; or modifying the BIOS to identify the NVM as the non-volatile HDD cache. For example, in a case where the NVM includes first and second NVM modules, the method can further include: copying the boot portions of the O/S to the first NVM module and defining the logical hybrid drive to include the first NVM module, to operate the first NVM module in the hybrid drive mode; and operating the second NVM module in a normal storage mode while the first NVM module operates in the hybrid drive mode.

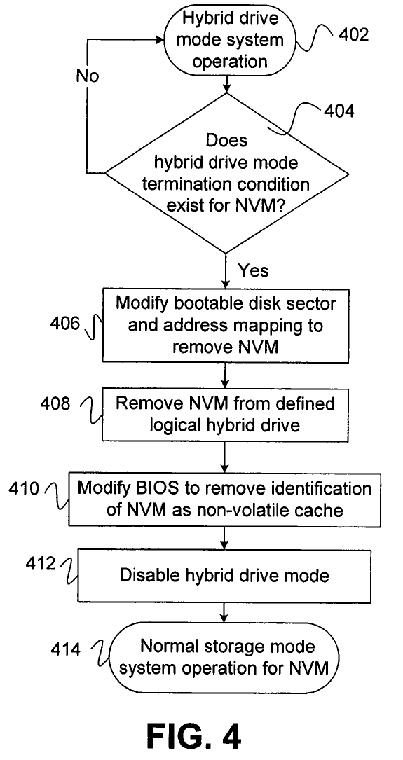

FIG. 4 illustrates a method of disabling or terminating a hybrid cache mode in a non-volatile memory according to an embodiment of the present invention. Step 402 in FIG. 4 is similar to step 318 in FIG. 3 as it represents the system operating in hybrid drive mode.

Referring to FIGS. 2A and 4, in step 404, a determination is made as to whether a hybrid drive mode termination condition exists for the NVM 202. The hybrid drive mode termination condition can include: user selection of a normal storage mode for the NVM; removal, disconnection or ejection of the NVM 202. The system can monitor for hybrid mode termination conditions, either periodically or at particular times or events, or can rely on notification of a termination condition prior to disabling the hybrid drive mode. In step 406, the bootable disk sector and address mapping is modified to remove the NVM 202. In step 408, the NVM is removed from the defined (or assigned) logical hybrid drive. In step 410, the BIOS is modified to remove the identification of NVM 202 as non-volatile cache. In step 412, the hybrid drive mode is disabled. In step 414, the system returns to normal storage mode for the NVM and to non-hybrid mode for the HDD 204.

In other words, advantageously the hybrid drive mode can be disabled in response to a hybrid drive mode termination condition for the NVM, such as disconnection or removal of the NVM. After the step of disabling, the NVM can be removed from the defined logical hybrid drive, and the bootable disk sector and address mapping can be modified to remove the NVM. In a presently preferred embodiment including a memory card slot, the slot includes a securing means to prevent accidental disconnection of the memory card (such as unseating, removal, or ejection) from the computer system when the card is being used in hybrid drive mode. The securing means can be a hardware implementation, such as a latch.

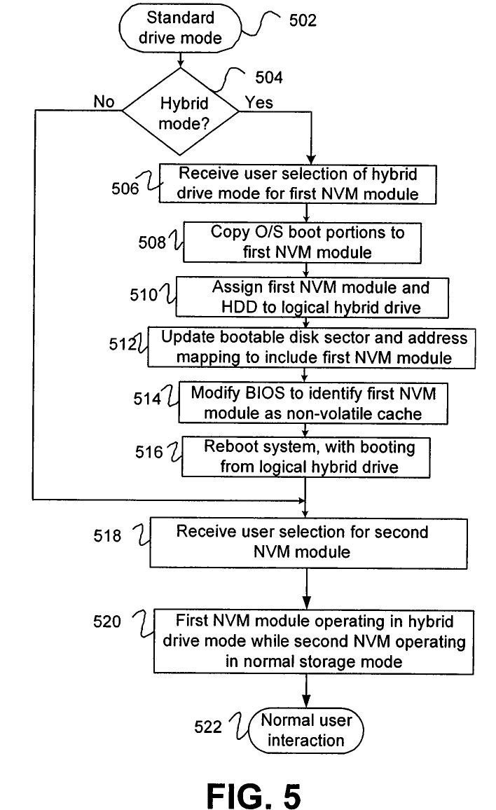

FIG. 5 illustrates a method of enabling a hybrid cache mode in a first NVM module while enabling a data storage in second NVM module according to an embodiment of the present invention. Embodiments of the present invention support the use of a plurality of NVM modules, such as a plurality of flash memory cards, and the operation in hybrid mode in one NVM module, while another NVM module operates in a normal storage mode. When a user selects “hybrid mode” after booting PC system in normal mode, if there are already several flash memories are inserted in each slot, the user can select which one(s) is/are going to be used in hybrid drive mode. A drive name can be assigned with ease by an O/S supporting utility. The address mapping can vary depending on how many flash memories are involved in the hybrid disk system and the density of each flash memory card. More than one flash memory card can be used as a hybrid disk system and they do not have to be same type of flash card. Also, some NVMs can be used in hybrid mode while others are used in normal storage mode. In other words, the method enables concurrent operation of hybrid disk mode in a first NVM module and in normal storage mode in a second NVM module.

Referring to FIGS. 2B and 5, the method begins in step 502 with the system in standard drive mode, which was discussed in relation to FIG. 3. In step 504, a user selects the desired mode of operation for the NVM modules 252-1 and 252-2, which in this case includes selecting hybrid drive mode for the first NVM module 252-1 and normal storage mode for the second NVM module 252-2. Steps 506-516 are similar to steps 306-316 in FIG. 3, with the operations being performed in relation to the first NVM module 252-1. Upon completion of step 516, the system receives a user selection of data storage for the second NVM module 252-2 in step 518. The second NVM module 252-2 is set to operate in normal storage mode, typically including recognition by the O/S of the second NVM module 252-2 as a removable disk. Thereafter, the first NVM module 252-1 operates in hybrid drive mode (along with the HDD as part of the logical hybrid drive), while the second NVM module 252-2 operates in a normal storage mode, in step 520. Upon completion of the hybrid drive mode system operation in step 520 or non-hybrid mode (i.e., the negative determination in step 504, which is effectively a selection of normal storage mode), the PC enters a state of normal user interaction in step 522. Alternatively, step 518 can be performed before step 516, and even before step 506. Effectively, if a hybrid drive mode is not selected, that effective selection is stored and can be acted on at any suitable time. For example, step 518 can represent acting on a previously received selection.

While a method according to an embodiment of the present invention has been described in relation to a system in which an O/S has been pre-installed, it is to be understood that a similar method can be applied during O/S installation to a system on which the O/S has not yet been installed.

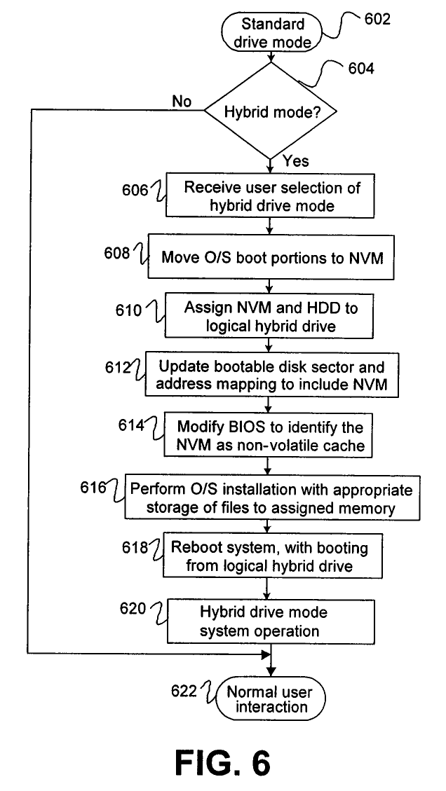

FIG. 6 illustrates a method of enabling a hybrid cache mode in a non-volatile memory upon operating system installation according to an embodiment of the present invention. Referring to FIG. 6, the standard drive mode in step 602 includes reading the O/S from a bootable disk (such as a CD or DVD). The user selection step 604 is then performed during preparation for initial O/S installation, so that all required files are installed to the HDD and NVM from the beginning. The NVM has to be inserted or physically installed prior to the user selection step. Steps 606-614 are similar to steps 306-314 of FIG. 3, but in step 608 the boot portions of the O/S are moved to the NVM and a copy is not left on the HDD. In this embodiment, in step 616 the O/S installation is performed from start to completion, with appropriate storage of files to the assigned memory. Upon completion of step 616, steps 618 and 620 are executed, which are similar to steps 316 and 318 of FIG. 3. Upon completion of the hybrid drive mode system operation in step 620 or non-hybrid mode (i.e., the negative determination in step 604), the PC enters a state of normal user interaction in step 622. The method shown in FIG. 6 can be implemented in the hybrid hard drive configurations shown in FIGS. 2A and 2B.

In relation to FIG. 6, the selection of “hybrid mode” is therefore performed once upon user selection, and the PC system demands the NVM in order to boot PC system, since it can no longer boot from the hard disk drive. If one NVM is not enough for the hybrid mode, a second NVM can be used as a data storage. If the flash memory card is changed, the O/S should be re-installed in order to: recognize the density of the flash memory card and restore bootable O/S parts; or restore bootable codes to the rotating hard disk. This embodiment provides more free space in the rotating hard disk drive, but, the flexible selection between normal mode and hybrid disk mode is not supported, resulting in a dedicated flash memory card for PC booting.

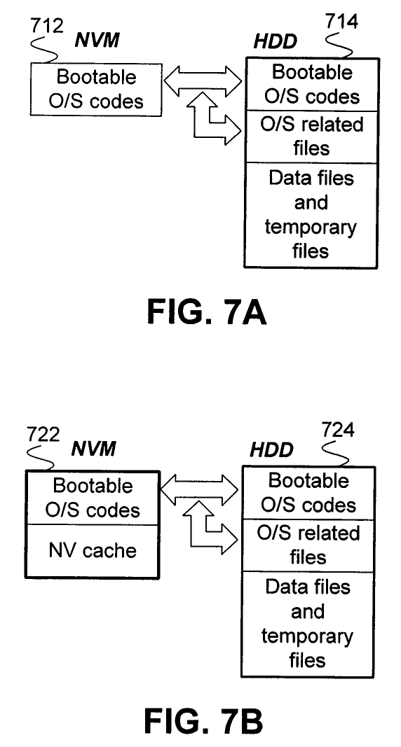

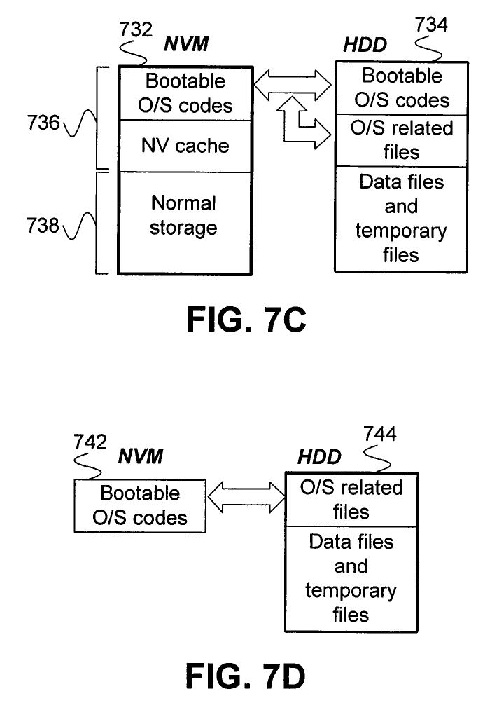

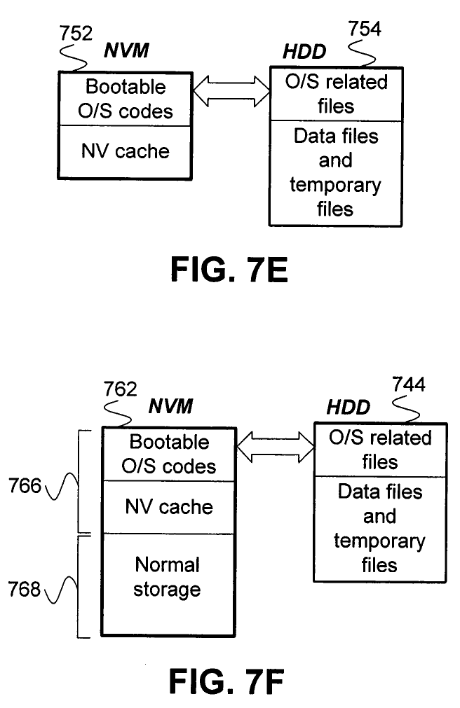

FIGS. 7A-7F illustrate allocation of bootable operating system codes, or boot portions of the O/S, in a non-volatile memory and in a hard disk drive according to embodiments of the present invention.

Referring to FIG. 7A, a non-volatile memory (NVM) 712 only has sufficient capacity to store the bootable O/S codes, and is in communication with a rotating hard disk drive (HDD) 714, which still stores the bootable O/S codes and other O/S related files. Referring to FIG. 7B, an NVM 722 has sufficient capacity to store the bootable O/S codes as well as to have a portion of its memory assigned as non-volatile cache, as part of a hybrid hard disk. An HDD 724 stores similar data as the HDD 714 in FIG. 7A. FIGS. 7A and 7B illustrate NVM and HDD data allocation subsequent to the method of FIG. 3, in which case hybrid drive mode can be disabled without reinstalling the O/S.

Referring to FIG. 7C, an NVM 732 has sufficient capacity to store the bootable O/S codes, act as non-volatile cache, and act as additional storage in normal storage mode. The NVM 732 is in communication with the HDD 734, which still stores the bootable O/S codes and other O/S related files. The NVM 732 in FIG. 7C is advantageously a high capacity NVM, which can be logically separated into a first sub-block, or first logical NVM module, 736 and a second sub-block, or second logical NVM module, 738. The first logical NVM module 736 can operate in a hybrid drive mode while the second logical NVM module 738 concurrently operates in a normal storage mode. This is similar in nature to the concurrent operation of two physically separate NVMs in differing modes, but in this example the two NVMs are not physical NVMs but are logically defined NVMs that are part of the same physical NVM. A logically defined NVM, or logical NVM module, can include, or be spread over, one or more physical NVMs.

FIGS. 7D and 7E illustrate NVM and HDD data allocation subsequent to FIG. 6, after which booting is only performed via the NVM, unless the O/S is reinstalled. In FIGS. 7A and 7B, the rotating HDDs 714 and 724 retain the bootable O/S codes in order to permit switching the NVM between hybrid drive mode and normal storage mode without reinstallation of the O/S. Referring to FIGS. 7D and 7E, HDDs 744 and 754 do not retain the bootable O/S codes, so switching the NVM to a normal storage mode requires reinstallation of the O/S on the hard disk drive. NVMs 742 and 752 store similar data as the NVMs 712 and 722, respectively.

Referring to FIG. 7F, an NVM 762 has sufficient capacity to store the bootable O/S codes, act as non-volatile cache, and act as additional storage in normal storage mode. The NVM 762 is in communication with the HDD 764, which is similar to the HDD 734 of FIG. 7C. The NVM 762 is similar to the NVM 732 in FIG. 7C in that it is advantageously a high capacity NVM, which can be logically separated into a first logical NVM module 766 and a second logical NVM module 768.

As mentioned in relation to FIG. 4, embodiments of the present invention provide the ability to use a plurality of memory cards in hybrid disk mode and/or normal storage mode. For example, a plurality of flash memory cards can be used in hybrid disk mode. In another example, if there are two flash memory cards in a PC system, one can be used in hybrid disk mode, while the other is used in normal storage mode.

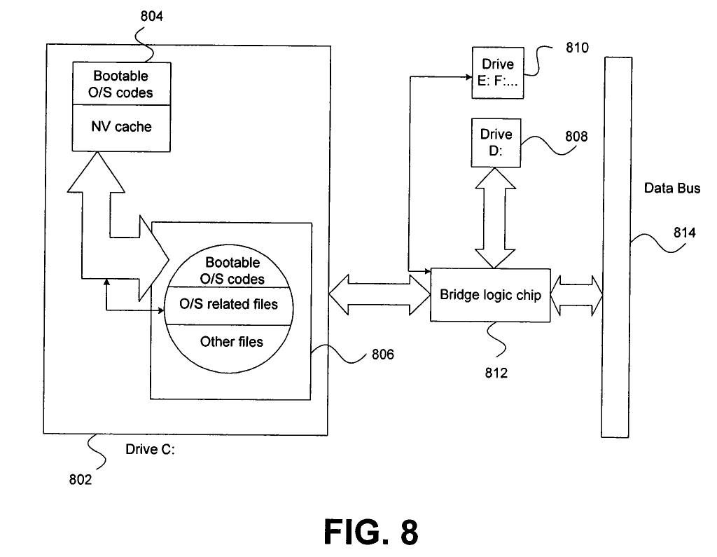

FIGS. 8-10 illustrate disk assignment after enabling a hybrid cache mode in a non-volatile memory according to embodiments of the present invention, in particular considering cases where a plurality of flash memory cards can be used.

Referring to FIG. 8 a hybrid drive 802 includes an NVM 804, such as a flash memory card, with high memory capacity that can comprise both bootable O/S codes and NV cache space. This high capacity NVM 804 is defined to be part of the logical bootable disk, “Drive C:”, along with an HDD 806. Other NVMs 808 for “Drive D:” and 810 for “Drive E: F: . . . ” are shown to be operable in normal storage mode. A bridge logic chip 812 facilitates communication between the hybrid drive 802 and the other NVMs 808 and 810, as well as between the hybrid drive 802 and the data bus 814, such as a PCI bus.

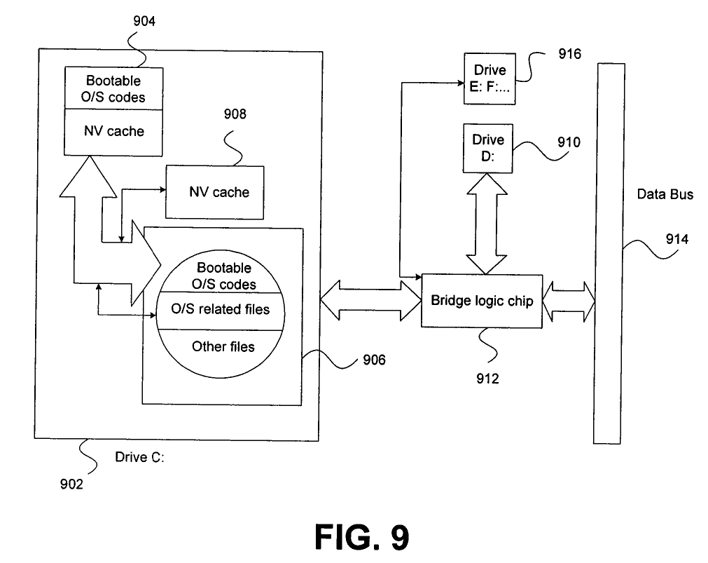

Referring to FIG. 9, a hybrid drive 902 includes two NVM modules 904 and 908 as well as an HDD 906. As such, two NVM modules are used in hybrid drive mode and both are defined to be part of the logical bootable disk. For example, one Compact Flash NVM and one SD NVM can be used, illustrating that it is not necessary to have similar formats of NVM for the same function. Other NVMs 910 and 916 operate in normal storage mode while the NVM modules 904 and 908 operate in hybrid drive mode.

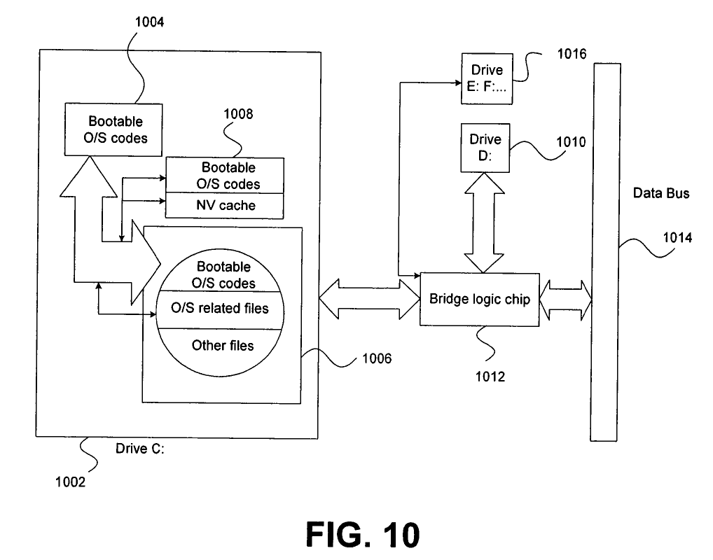

FIG. 10 depicts an example of a single NVM that does not have the capacity to store all bootable O/S codes. Referring to FIG. 10, a hybrid drive 1002 includes two NVM modules 1004 and 1008 as well as an HDD 1006. In this case, the NVM module 1004 stores a first portion of the boot portions of the O/S, and the NVM module 1008 stores a second portion of the boot portions of the O/S, and also includes space to act as NV cache. A bridge logic chip 1012 and a data bus 1014 are similar to the bridge logic chip 812 and data bus 814 of FIG. 8. Also, other NVM modules 1010 and 1016 operate in a same manner as the NVM modules 904 and 908 of FIG. 9.

As illustrated in FIGS. 8-10, embodiments of the present invention can include different block mapping for bootable disk elements. In each case, there is a relationship between the functional role, logical mapping and physical elements. While in some instances each physical element can have a distinct logical mapping and functional role, each functional role can be divided between a plurality of physical elements, as described above, or there can be any combination of functional roles and logical mapping with one or more physical elements.

In other words, in an aspect the present invention provides a computer system including an HDD, an NVM, an O/S and a BIOS. The computer system includes a machine-readable medium storing commands and instructions which, when executed, cause a processor to perform a method of configuring a non-volatile memory. The method includes: receiving a user selection of a hybrid drive mode for the NVM; copying boot portions of the O/S to the NVM in response to the user selection; and assigning the hard disk drive and the NVM to a logical hybrid drive of the computer system, or as a logical hybrid drive of the computer system. The NVM can be a non-volatile HDD cache.

Advantageously, the NVM can be removable and replaceable without performing an internal computer system hardware upgrade. The NVM can be a flash memory card. The computer system can further include a receiver for receiving the NVM, the receiver being in electrical communication with the processor. The receiver can be a slot for receiving the NVM, which is accessible by a user without opening the outer casing. The slot can include a securing means to prevent disconnection of the NVM when the NVM is being used in hybrid drive mode. For example, in the case where the NVM includes first and second NVM modules, the first NVM module can include the boot portions of the O/S and the logical hybrid drive is defined to include the first NVM module; the first NVM module being operable in the hybrid drive mode. The second NVM module is operable in a normal storage mode while the first NVM module is operable in the hybrid drive mode. The first and second NVM modules can be logical NVM modules or physical NVM modules.

As mentioned earlier, software (and possibly hardware) for implementing embodiments of the present invention can be provided as an upgrade kit or add-on module for an existing computer system, requiring no internal hardware upgrade. Many users may already have a multi-format card reader that accepts different types of non-volatile memory, and even have some memory cards that are presently used with other electronic devices, such as digital cameras or personal digital assistants (PDAs). In that case, the user need only acquire the software upgrade to provide the ability to use the memory in either a hybrid disk mode or a normal storage mode. The software upgrade can be provided on a computer-readable, or machine-readable, medium.

Therefore, in another aspect, the present invention provides a machine-readable medium storing commands and instructions which, when executed, cause a processor to perform a method of configuring an NVM in a computer system having an HDD, an O/S and a BIOS. The method includes: receiving a user selection of a hybrid drive mode for the NVM; copying boot portions of the O/S to the NVM in response to the user selection; and assigning the hard disk drive and the NVM to a logical hybrid drive of the computer system, or as a logical hybrid drive of the computer system. The commands and instructions stored on the machine-readable medium can perform other steps in the method, as described earlier.

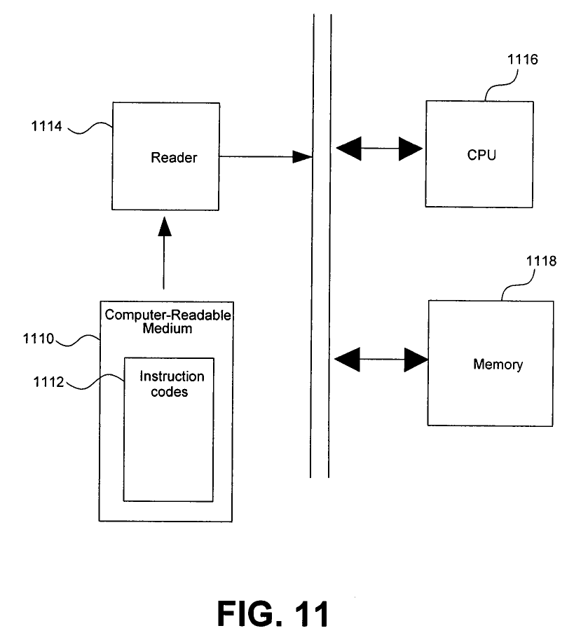

FIG. 11 shows a machine-readable medium storing commands and instructions according to an embodiment of the present invention. Referring to FIG. 11, a computer-readable medium 1110 containing instruction codes is provided to a reader 1114 of a computer system. The reader 1114 reads the instruction codes 1112 and the read codes are provided to a CPU 1116 of the computer system. The CPU 1116 processes the read codes and the processed codes are stored in a memory 1118 (e.g., a hard disk) of the computer system. The CPU 1116 reads the stored codes and their instructions are executed, so that the CPU 1116 performs operations defined by the instruction codes 1112. In a case where the instruction codes 1112 contained in the computer-readable medium 1110 defines a method of configuring an NVM (not shown) in a computer system as described earlier, the CPU 1116 performs to execute the method for configuring the NVM.

In a further aspect, the present invention provides a non-volatile memory device operable in a hybrid disk mode or a normal storage mode in response to a user mode selection.

In the embodiments described above, the device elements and circuits are connected to each other as shown in the figures, for the sake of simplicity. In practical applications of the present invention to a hybrid drive configuration of NVM and HDD, circuits, elements, devices, etc. may be connected directly to each other. As well, circuits, elements, devices, etc. may be connected indirectly to each other through other circuits, elements, devices, etc., necessary for operation of a hybrid disk configuration of NVM and HDD. Thus, in actual configuration of the hybrid disk, the circuit, elements, devices, etc. are coupled with (directly or indirectly connected to) each other.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of configuring a non-volatile memory (NVM) in a computer system having a hard disk drive, an operating system (O/S) and a basic input/output system (BIOS), the method comprising:
receiving a user selection of a hybrid drive mode for the NVM;
copying boot portions of the O/S to the NVM in response to the user selection; and
assigning the hard disk drive (HDD) and the NVM as a logical hybrid drive of the computer system.

2. The method of claim 1 further comprising:
prior to the step of receiving the user selection, configuring the NVM to operate in a normal storage mode.

3. The method of claim 1 wherein the step of assigning comprises assigning the HDD and the NVM to a logical hybrid bootable disk.

4. The method of claim 3 wherein the step of assigning comprises modifying bootable disk sector and address mapping to include the NVM.

5. The method of claim 3 wherein the step of assigning comprises modifying the BIOS to identify the NVM as a non-volatile HDD cache.

6. The method of claim 1 wherein the NVM includes first and second NVM modules, further comprising:
copying the boot portions of the O/S to the first NVM module and defining the logical hybrid drive to include the first NVM module, to operate the first NVM module in the hybrid drive mode; and
operating the second NVM module in a normal storage mode while the first NVM module operates in the hybrid drive mode.

7. The method of claim 1 further comprising disabling the hybrid drive mode in response to a hybrid drive mode termination condition for the NVM.

8. The method of claim 7 further comprising, after the step of disabling, removing the NVM from the defined logical hybrid drive.

9. The method of claim 8 further comprising modifying bootable disk sector and address mapping to remove the NVM.

10. A computer system including a hard disk drive (HDD), a non-volatile memory (NVM), an operating system (O/S) and a basic input/output system (BIOS), comprising:
a machine-readable medium storing commands and instructions which, when executed, cause a processor to perform a method of configuring a non-volatile memory, the method including:
receiving a user selection of a hybrid drive mode for the NVM;
copying boot portions of the O/S to the NVM in response to the user selection; and
assigning the hard disk drive and the NVM as a logical hybrid drive of the computer system.

11. The computer system of claim 10 wherein the NVM is removable and replaceable without performing an internal computer system hardware upgrade.

12. The computer system of claim 10 wherein the NVM comprises a flash memory card.

13. The computer system of claim 10 further comprising a receiver for receiving the NVM, the receiver being in electrical communication with the processor.

14. The computer system of claim 13 wherein the receiver comprises a slot for receiving the NVM, the slot being accessible by a user without opening the outer casing, the slot including a securing means to prevent disconnection of the NVM when the NVM is being used in hybrid drive mode.

15. The computer system of claim 10 wherein the NVM includes first and second NVM modules:
the first NVM module including the boot portions of the O/S, the logical hybrid drive being defined to include the first NVM module, the first NVM module being operable in the hybrid drive mode; and
the second NVM module being operable in a normal storage mode while the first NVM module is operable in the hybrid drive mode.

16. The computer system of claim 15 wherein the first and second NVM modules are logical NVM modules.

17. The computer system of claim 15 wherein the first and second NVM modules are physical NVM modules.

18. A machine-readable medium storing commands and instructions which, when executed, cause a processor to perform a method of configuring a non-volatile memory (NVM) in a computer system having a hard disk drive, an operating system (O/S) and a basic input/output system (BIOS), the method comprising:
receiving a user selection of a hybrid drive mode for the NVM;
copying boot portions of the O/S to the NVM in response to the user selection; and
assigning the hard disk drive and the NVM as a logical hybrid drive of the computer system.

19. The machine-readable medium of claim 18 wherein, the method comprises, prior to the step of receiving the user selection, configuring the NVM to operate in a normal storage mode.

20. The machine-readable medium of claim 18 wherein the logical hybrid drive comprises a logical bootable disk.

21. The machine-readable medium of claim 20 wherein the step of assigning comprises assigning the HDD and the NVM to a logical hybrid bootable disk.

22. The machine-readable medium of claim 20 wherein the step of assigning comprises modifying bootable disk sector and address mapping to include the NVM.

23. The machine-readable medium of claim 20 wherein the step of assigning comprises modifying the BIOS to identify the NVM as a non-volatile HDD cache.

24. The machine-readable medium of claim 18 wherein the NVM includes first and second NVM modules, the method further comprising:
copying the boot portions of the O/S to the first NVM module and defining the logical hybrid drive to include the first NVM module, to operate the first NVM module in the hybrid drive mode; and
operating the second NVM module in a normal storage mode while the first NVM module operates in the hybrid drive mode.

25. The machine-readable medium of claim 18 wherein the method further comprises disabling the hybrid drive mode in response to a hybrid drive mode termination condition for the NVM.

26. The machine-readable medium of claim 25 wherein the method further comprises after the step of disabling, removing the NVM from the defined logical hybrid drive.

27. The machine-readable medium of claim 26 wherein the method further comprises modifying bootable disk sector and address mapping to remove the NVM.
